(19) United States
(12) Patent Application Publication
(10) Pub. No.: US 2024/0052930 A1
(43) Pub. Date: Feb. 15, 2024

(54) BUTTERFLY VALVE ASSEMBLY, IN PARTICULAR FOR A GAS FLOW IN A FUEL CELL SYSTEM

(71) Applicant: Purem GmbH, Neunkirchen (DE)

(72) Inventors: Markus Lory, Stuttgart (DE); Matthias Grün, Altbach (DE); Andreas Wacker, Plochingen (DE)

(21) Appl. No.: 18/448,592

(22) Filed: Aug. 11, 2023

(30) Foreign Application Priority Data
Aug. 11, 2022 (DE) 10 2022 120 290.9
Jul. 27, 2023 (EP) 23 187 971.9

(51) Int. Cl. F16K 1/22

(52) U.S. Cl. CPC F16K 1/224; H01M 50/317

(57) ABSTRACT

A butterfly valve assembly includes a butterfly valve housing providing a gas flow and a butterfly valve adjustable in the butterfly valve housing between a closed position and an open position. The valve has a disk-shaped butterfly valve element supported on a pivot shaft rotatable about a pivot shaft axis. The shaft has a first shaft end portion for coupling to a pivot shaft drive and which, in a first bearing region, is supported on the butterfly valve housing and a second pivot shaft end portion which, in a second bearing region, is supported on the butterfly valve housing. At least one bearing region out of the first and second bearing regions includes a bearing arrangement rotatably supporting the shaft and having a bearing projection arranged on the shaft to surround the shaft axis and protruding in the direction of a counterpart bearing region on the butterfly valve housing.

### CROSS-REFERENCE TO RELATED APPLICATIONS

This application claims priority of German patent application no. 10 2022 120 290.9, filed Aug. 11, 2022, and European patent application 23 187 971.9, filed Jul. 27, 2023, the entire contents of both applications being incorporated herein by reference.

### TECHNICAL FIELD

The present disclosure relates to a butterfly valve assembly, for example for a gas flow in a fuel cell system, which can be used for example in a vehicle for the purpose of providing electrical energy.

### BACKGROUND

In such fuel cell systems, depending on the operating state, it is necessary to conduct different gas flows through or past the anode region, and through or past the cathode region, of a fuel cell or of a fuel cell stack. Here, stringent demands are placed on the leak-tightness of butterfly valve assemblies used to regulate such gas flows, in order to ensure, in particular in operating states in which a particular gas flow should not be conducted through a fuel cell or should not be conducted past a fuel cell, that leakage flows can be ruled out and substantially no gas can escape to the surroundings.

### SUMMARY

It is an object of the present disclosure to provide a butterfly valve assembly, in particular for a gas flow in a fuel cell system, in particular in a vehicle, which butterfly valve assembly can substantially prevent gas leakage while being of structurally simple configuration.

The object is achieved according to the invention by a butterfly valve assembly, in particular for a gas flow in a fuel cell system, in particular in a vehicle, including a butterfly valve housing which provides a gas flow channel, a butterfly valve which is adjustable in the butterfly valve housing between a closed position, substantially preventing a gas flow through the gas flow channel, and at least one open position, opening up the gas flow channel for a passage of flow, and which has a disk-shaped butterfly valve element supported on a pivot shaft which is rotatable about a pivot shaft axis, the pivot shaft having a first pivot shaft end portion, which is provided for coupling to a pivot shaft drive and which in a first bearing region is supported on the butterfly valve housing so as to be rotatable about the pivot shaft axis, and a second pivot shaft end portion, which in a second bearing region is supported on the butterfly valve housing so as to be rotatable about the pivot shaft axis, at least one bearing region out of the first bearing region and second bearing region including a bearing arrangement which rotatably supports the pivot shaft and has a bearing projection, arranged on the pivot shaft so as to surround the pivot shaft axis and protruding in the direction of a counterpart bearing region on the butterfly valve housing, and, on the counterpart bearing region, has a bearing cutout, arranged so as to surround the pivot shaft axis and at least partially receiving the bearing projection.

The provision of the bearing projection and the bearing cutout receiving the bearing projection allows interaction in the manner of a ball joint, so that, even with the occurrence of relative movements between the pivot shaft and the pivot shaft housing that can lead to local tilting of the pivot shaft, in particular in the region of the at least one bearing region, a closure of the butterfly valve assembly that is leak-tight with respect to the escape of gas is achieved.

Since the first pivot shaft end portion of the pivot shaft has to be led through the associated first bearing region in order to enable coupling to the pivot shaft drive, it is particularly conducive to gas-tight closure if the at least one bearing region is the first bearing region. In the second bearing region, in which the pivot shaft does not need to be led with its second pivot shaft axis through the bearing region or out of the bearing region, a gas-tight closure can be provided by other measures, for example complete encapsulation of the second pivot shaft end portion by way of a bearing bushing.

To achieve a completely gas-tight closure over the entire circumference of the pivot shaft, it is proposed that the bearing projection and the bearing cutout annularly surround the pivot shaft axis.

The counterpart bearing region may include a bearing ring which is supported on the butterfly valve housing and which has an opening through which the pivot shaft extends. At the bearing ring, it is thus possible for the pivot shaft to be supported in an axial direction and also in a radial direction so as to be rotatable about the pivot shaft axis.

In order, for the bearing ring, to be able to ensure a defined position on the butterfly valve housing, the bearing ring may be received in a bearing bushing which is supported on the butterfly valve housing.

To provide the configuration of the bearing cutout interacting in the manner of a ball joint with the bearing projection, the bearing cutout may be of substantially frustoconical form and thereby provide a substantially frustoconically shaped bearing surface for the bearing projection.

The bearing region may include on the pivot shaft a radially protruding pivot shaft head, wherein the bearing projection is formed on a side of the pivot shaft head that faces toward the counterpart bearing region.

For a construction requiring a small number of components, it is proposed that the pivot shaft head forms an integral constituent part of the pivot shaft. Note that, in the context of the present disclosure, this integral configuration means that the pivot shaft head is formed in one piece, that is, monolithically, with the remaining portions of the pivot shaft and is not provided by a separate component that is to be attached to the pivot shaft.

In order to promote the interaction of the bearing projection with the bearing cutout in the manner of a ball joint, it is proposed that the bearing projection is formed so as to bulge in the direction of the counterpart bearing region.

The disclosure furthermore relates to a fuel cell system, in particular for a vehicle, including at least one butterfly valve assembly according to the disclosure.

### BRIEF DESCRIPTION OF DRAWINGS

The invention will now be described with reference to the drawings wherein:

FIG. 1 shows a schematic diagram of a fuel cell system of a vehicle;

FIG. 2 shows a butterfly valve assembly for a fuel cell system; and,

FIG. 3 shows a sectional view of a bearing region for a pivot shaft of the butterfly valve assembly.

### DETAILED DESCRIPTION

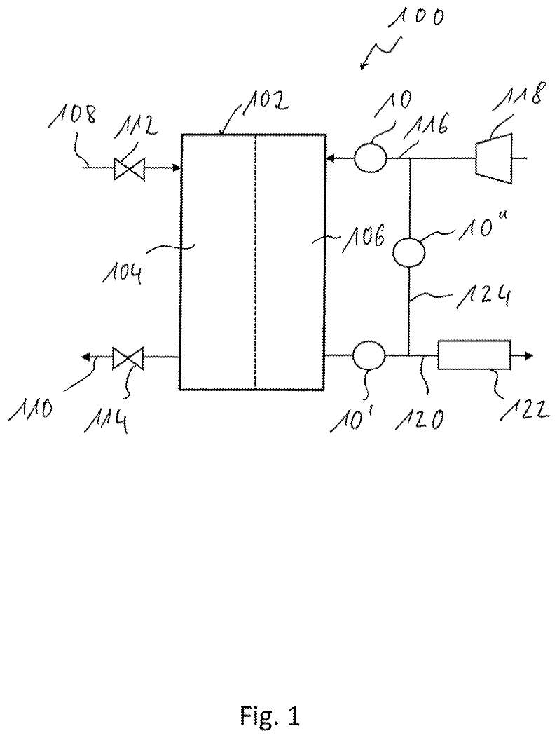

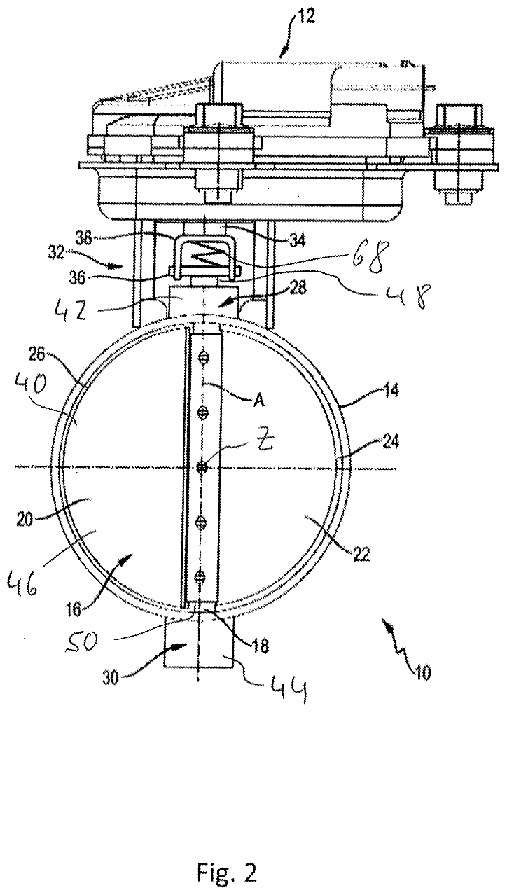

Before embodiments according to the disclosure of a butterfly valve assembly for a fuel cell system are described in detail below, in particular with regard to a structure thereof which is intended for providing a sealed closure, the basic construction of a fuel cell system which can be used to provide electrical energy for example in a vehicle will be described with reference to FIG. 1, and the basic construction of a butterfly valve assembly which, in particular when assigned to the cathode region of such a fuel cell system, can be used to regulate the gas flow or shut off a flow through the cathode region will be discussed with reference to FIG. 2.

The fuel cell system 100 illustrated in FIG. 1 includes, as a main system region, a fuel cell denoted generally by 102, having an anode region 104, which is to be fed with hydrogen or with a gas containing hydrogen, and having a cathode region 106, which is to be fed with oxygen or with a gas containing oxygen, for example air.

The anode region 104 is assigned a feed line 108 and a discharge line 110 with respective valves 112, 114 in order to allow the hydrogen or the gas containing hydrogen to be introduced into the anode region 104 and/or to allow anode off-gas to be discharged therefrom, and if necessary to allow the anode region 104 to be closed off entirely.

The cathode region 106 is assigned a feed line 116 via which the gas containing oxygen, that is, for example air, can be introduced into the cathode region, for example via a compressor 118 or the like. A butterfly valve assembly denoted generally by 10 is provided in the feed line 116, via which butterfly valve assembly the gas flow via the feed line 116 can be regulated, or the cathode region 106 can be substantially gas-tightly closed off in its inlet region.

For the discharge of cathode off-gas, the cathode region 106 is assigned a discharge line 120. This leads to a fuel cell off-gas system 122 in which, for example, water contained in the cathode off-gas can be separated off using a water separator. Also arranged in the discharge line 120 is a further butterfly valve assembly 10′ via which the discharge line 120 and thus outlet region of the cathode region 106 can be substantially gas-tightly closed off.

A bypass line 124 runs between the feed line 116 and the discharge line 120 of the cathode region 106. A butterfly valve assembly 10″ is also arranged in the bypass line 124, via which butterfly valve assembly the gas flow via the bypass line 124 can be regulated or the bypass line 124 can be substantially gas-tightly closed off.

Note that the construction of the fuel cell system 100 as illustrated in FIG. 1 and described above represents merely one example out of numerous different possibilities for the feed and discharge of gas, in particular at the cathode region 106. It is essential that at least one and optionally multiple butterfly valve assemblies 10, 10′, 10″ are provided so as to be assigned to the cathode region 106, wherein, if multiple such butterfly valve assemblies 10, 10′, 10″ are provided, these may in principle be structurally identical to one another, or may also be of different configuration depending on the region in which they are positioned and what degree of gas-tightness they are intended to provide.

The butterfly valve assembly 10 illustrated in FIG. 2 and used for example in the fuel cell system 100 of FIG. 1 includes a butterfly valve drive 12 based for example on an electric motor and includes, in a butterfly valve housing 14 which is tubular and bounds a gas flow channel 46, a butterfly valve denoted generally by 16.

The butterfly valve 16 includes a disk-shaped butterfly valve element 24 which is supported on a pivot shaft 18 so as to be pivotable about a pivot shaft axis A and which has two butterfly valve element parts 20, 22, which each provide one valve wing. A butterfly valve seat 26 is provided on the butterfly valve housing 14 so as to be assigned to the butterfly valve 16, against which butterfly valve seat the butterfly valve 16 lies, when in a closed position, by way of a closure region 40 which is situated radially at the outside in relation to a central region Z of the butterfly valve 16.

To move the butterfly valve 16 between the closed position and a fully opened position, in which the disk-shaped butterfly valve element 24 is oriented substantially orthogonally with respect to the plane of the drawing of FIG. 2 and thus substantially completely opens up the gas flow channel 46 in the butterfly valve housing 14 for a passage of flow, a drive shaft 34 of the butterfly valve drive 12 is coupled rotationally conjointly to the pivot shaft 18, which is supported in bearing regions 28, 30 on the butterfly valve housing 14 so as to be pivotable about the pivot shaft axis A, via a coupling arrangement 32. Here, the coupling arrangement 32 includes for example a coupling part 38, which is connected rotationally conjointly to the drive shaft 34, and a coupling part 36, which is connected rotationally conjointly to the pivot shaft 18 and which engages with the coupling part 38 with rotational coupling action.

Each of the two bearing regions 28, 30 includes a bearing bushing 42, 44, which is supported on the butterfly valve housing 14 and which is for example fixed to an outer circumferential surface thereof by welding and in which a respective axial end portion of the pivot shaft 18 is received so as to be rotatable about the pivot shaft axis A.

Of the two bearing regions 28, 30, the bearing region 28 forms a first bearing region in which a first pivot shaft end portion 48 of the pivot shaft 18 is rotatably mounted. The first pivot shaft end portion 48 projects axially beyond the first bearing region 28 in order to be coupled via the coupling arrangement 32 to the drive shaft 34. The bearing region 30 forms a second bearing region in which a second pivot shaft end portion 50 of the pivot shaft 18 is mounted so as to be rotatable about the pivot shaft axis A.

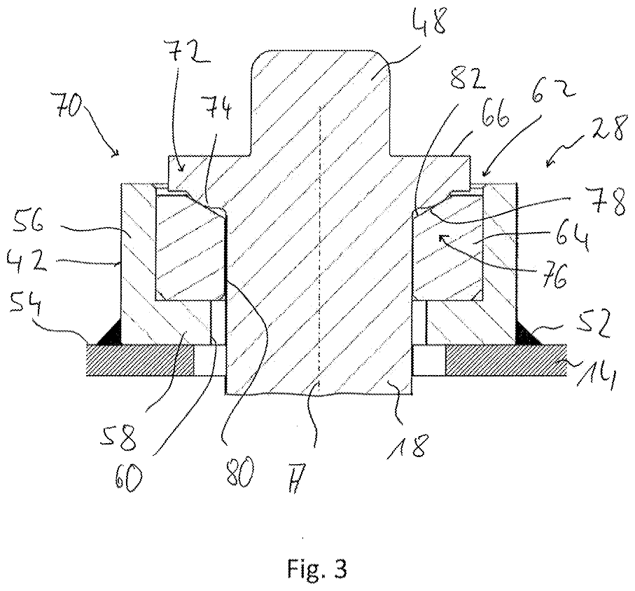

FIG. 3 illustrates the first bearing region 28 in detail. The first bearing region 28 includes the bearing bushing 42, which is for example fixed gas-tightly to the outer circumferential surface 54 of the butterfly valve housing 14 by a fully encircling weld seam 52. The bearing bushing 42 includes a circumferential wall 56 and a base 58 which adjoins the circumferential wall and which has an opening 60 through which the pivot shaft 18 extends. Note that the bearing bushing 42 may also have only the circumferential wall 56 and no base wall, which, in particular in the case of the bulged contour of the outer circumferential surface 54 of the butterfly valve housing 14, allows the bearing bushing 42 to be more easily fixed to the butterfly valve housing 14 and also allows a configuration of the bearing bushing 42 which is easier to produce.

A bearing unit denoted generally by 62 is received in the bearing bushing 42. In the embodiment illustrated, the bearing unit 62 includes a bearing ring 64 which receives and radially supports the first pivot shaft end portion 48, and is thus configured as a plain bearing unit. The bearing ring 64 is received in the bearing bushing 42 for example with an interference fit, and thus held in a defined axial position on the circumferential wall 56 of the bearing bushing 42. The pivot shaft 18 is, in a manner described in detail below, supported axially on the bearing ring 64 by way of a flange-like pivot shaft head 66 which is provided on the first pivot shaft end portion 48. A preload force that holds the pivot shaft head 66 of the pivot shaft 18 in contact with the bearing ring 64 may be provided by a preload spring 68 which acts between the pivot shaft 18 or the coupling part 36, on the one hand, and the drive shaft 34 or the coupling part 38, on the other hand, such that the defined position of the bearing ring 64 in the bearing bushing 42 also determines a defined position of the pivot shaft 18, and thus of the butterfly valve 16 as a whole, in the butterfly valve housing 14.

For defined and in particular gas-tight axial and also radial support of the pivot shaft 18 in relation to the butterfly valve housing 14, a bearing arrangement denoted generally by 70 is provided. At the pivot shaft head 66, the bearing arrangement 70 includes a bearing region 72 which, on that axial side of the pivot shaft head 66 facing toward the bearing ring 64, includes a bearing projection 74 which surrounds, preferably without interruption and completely, the pivot shaft axis A. In terms of its annular structure completely surrounding the pivot shaft axis A, the bearing projection 74 is formed so as to bulge in a convex manner, that is, outwardly toward the bearing ring 64.

At the bearing ring 64, the bearing arrangement 70 includes a counterpart bearing region 76 which has a bearing cutout 78 which at least regionally axially receives the bearing projection 74. The bearing cutout 78, proceeding from an opening 80 which is formed in the bearing ring 64 and receives the pivot shaft 18, is formed so as to widen in a frustoconical manner radially outward and toward the pivot shaft head 66, and thereby provides a frustoconical bearing surface 82 for axial and radial support of the bulged bearing projection 74.

The bearing region 72, with its bearing projection 74, and the counter bearing region 76, with its bearing cutout 78, form a bearing arrangement which acts in the manner of a ball joint and which in principle allows at least slight tilting of the pivot shaft 18 at its first pivot shaft end portion 48. During the relative movement between the pivot shaft head 66 and the bearing ring 64 that occurs in this case, the bead-like or outwardly bulged bearing projection 74, which substantially provides a spherical contact region, remains in contact over its entire circumference with the bearing surface 82 of the bearing cutout 78. Such relative movements between the pivot shaft 18 and the bearing ring 64, or in principle the butterfly valve housing 14, thus do not lead to a local leak of the bearing arrangement 70.

In order to allow this relative movement between the first pivot shaft end portion 48 and the bearing ring 64 of the bearing unit 62, the opening 80 in the bearing ring 64 may be dimensioned in such a way that the pivot shaft 18 is consequently received with at least a small amount of radial play and, at its length portion extending through the bearing ring 64, the pivot shaft 18 can thereby tilt in relation thereto. In principle, this radial play may also be provided by bearing play which unavoidably occurs in the case of the bearing ring 64 being configured as a plain bearing ring, so that such relative movements leading to tilting of the pivot shaft 18 in relation to the bearing ring 64, which can arise for example if vibrations occur, can be limited to a minimum extent.

In the embodiment illustrated in FIG. 3 of the bearing arrangement 70, the bearing projection 74 bulging outward, that is, basically of convex form, has a relatively small radius of curvature. In principle, the bearing projection 74 could also be formed in such a way that the entire bearing projection 74 or the convex surface formed by it is provided by a spherical cap section which is formed concentrically with respect to the pivot shaft axis A.

Note further that the bearing surface 82 of the bearing ring 64, which is formed in the illustrated embodiment with a frustoconical shaping, could also be formed so as to bulge, in this case then to bulge in a concave manner, wherein the radius of curvature may correspond for example to the radius of curvature of the bearing projection 74 or a radius of curvature which is different from, in particular larger than, that for the bearing projection 74 may be provided for the bearing surface 82.

Note that, in principle, such a structure could also be provided in the second bearing region 30. Since it is however not intended for the pivot shaft 18 to be led out in the second bearing region 30, a gas-tight closure can for example also be achieved by virtue of the bearing bushing 44 of the second bearing region 30 completely encapsulating, that is, also axially encapsulating, the second pivot shaft end portion, for example by virtue of a cover which axially closes off the bearing bushing 44 being provided on a circumferential wall of the bearing bushing 44.

Finally, note further that, although the above-described butterfly valve assembly may particularly advantageously be used in the gas flow of a fuel cell system, it may also be used in other areas of application, for example in the exhaust-gas flow of an internal combustion engine.

It is understood that the foregoing description is that of the preferred embodiments of the invention and that various changes and modifications may be made thereto without departing from the spirit and scope of the invention as defined in the appended claims.

1. A butterfly valve assembly comprising:
a butterfly valve housing defining a gas flow channel;
a butterfly valve adjustable in said butterfly valve housing between a closed position so as to prevent a gas flow through said gas flow channel and at least one open position opening up said gas flow channel for a passage of flow;
a pivot shaft drive;
a pivot shaft rotatable about a pivot shaft axis and having a first pivot shaft end portion and a second pivot shaft end portion;
said butterfly valve having a disc-shaped butterfly valve element supported on said pivot shaft;
said first pivot shaft end portion being provided for coupling to said pivot shaft drive and, in a first bearing region, being supported on said butterfly valve housing so as to be rotatable about said pivot shaft axis;
said second pivot shaft end portion, in a second bearing region, being supported on said butterfly valve housing so as to be rotatable about said pivot shaft axis; and,
at least one bearing region out of said first and second bearing regions including a bearing arrangement rotatably supporting said pivot shaft and having a bearing projection arranged on said pivot shaft so as to surround said pivot shaft axis and protrude in a direction of a counterpart bearing region on said butterfly valve housing and, said bearing arrangement, on said counterpart bearing region, having a bearing cutout arranged so as to surround said pivot shaft axis and at least partially receive said bearing projection.

2. The butterfly valve assembly of claim 1, wherein said at least one bearing region is the first bearing region.

3. The butterfly valve assembly of claim 1, wherein said bearing projection and said bearing cutout annularly surround said pivot shaft axis.

4. The butterfly valve assembly of claim 1, wherein said counterpart bearing region includes a bearing ring supported on said butterfly valve housing and having an opening through which the pivot shaft extends.

5. The butterfly valve assembly of claim 4, wherein said bearing ring is received in a bearing bushing supported on said butterfly valve housing.

6. The butterfly valve assembly of claim 1, wherein said bearing cutout is of frustoconical form.

7. The butterfly valve assembly of claim 1, wherein said bearing region includes a radially protruding pivot shaft head on the pivot shaft; and, the bearing projection is formed on a side of the pivot shaft head facing toward said counterpart bearing region.

8. The butterfly valve assembly of claim 7, wherein said pivot shaft head forms an integral constituent part of the pivot shaft.

9. The butterfly valve assembly of claim 1, wherein said bearing projection is formed so as to bulge in the direction of said counterpart bearing region.

10. The butterfly valve assembly of claim 1, wherein said butterfly valve assembly is for a gas flow in a fuel cell system in a vehicle.

11. A fuel cell system including for a vehicle, the fuel cell system comprising:
a butterfly valve assembly including:
a butterfly valve housing defining a gas flow channel;
a butterfly valve adjustable in said butterfly valve housing between a closed position so as to prevent a gas flow through said gas flow channel and at least one open position opening up said gas flow channel for a passage of flow;
a pivot shaft drive;
a pivot shaft rotatable about a pivot shaft axis and having a first pivot shaft end portion and a second pivot shaft end portion;
said butterfly valve having a disc-shaped butterfly valve element supported on said pivot shaft;
said first pivot shaft end portion being provided for coupling to said pivot shaft drive and, in a first bearing region, being supported on said butterfly valve housing so as to be rotatable about said pivot shaft axis;
said second pivot shaft end portion, in a second bearing region, being supported on said butterfly valve housing so as to be rotatable about said pivot shaft axis; and,
at least one bearing region out of said first and second bearing regions including a bearing arrangement rotatably supporting said pivot shaft and having a bearing projection arranged on said pivot shaft so as to surround said pivot shaft axis and protrude in a direction of a counterpart bearing region on said butterfly valve housing and, said bearing arrangement, on said counterpart bearing region, having a bearing cutout arranged so as to surround said pivot shaft axis and at least partially receive said bearing projection.
